(19) United States
(12) Patent Application Publication
(10) Pub. No.: US 2007/0031568 A1
(43) Pub. Date: Feb. 8, 2007

(54) Supplemental dietary composition including caffeine, taurine and ginseng

(76) Inventors: Paul T. Gardiner, Mississauga (CA); Marvin A. Heuer, Mississauga (CA)

Correspondence Address: KENYON & KENYON LLP, ONE BROADWAY, NEW YORK, NY, 10004, US

(21) Appl. No.: 11/504,569

(22) Filed: Aug. 14, 2006

Related U.S. Application Data
(60) Provisional application No. 60/707,618, filed on Aug. 12, 2005.

(51) Int. Cl. A23F 3/00

(52) U.S. Cl. 426/597

(57) ABSTRACT

A dietary supplement and method for increasing energy and mental alertness of an individual, e.g. a human or an animal, is provided comprising at least Caffeine Anhydrous, Taurine, an extract of American Ginseng Root and extract of Green Tea leaf and tender shoots. Additionally, a method for increasing energy and mental alertness in an individual is also provided.

### CROSS-REFERENCES TO RELATED APPLICATIONS

This application claims priority to U.S. Provisional Patent Application No. 60/707,618, filed Aug. 12, 2005, the entirety of which is incorporate herein by reference.

### FIELD OF THE INVENTION

The present invention is directed to a dietary supplement used to increase energy and the mental alertness of an individual. A method for the same is also presented.

### BACKGROUND OF THE INVENTION

The increasing awareness of improving one's health has driven demand for functional beverages, and drinks. A functional beverage is a beverage that not only quenches thirst, but also has added nutritional benefits. There are multiple categories of functional beverage such as, herb-enhanced fruit drinks, ready-to-drink (RTD) teas, sports drinks, energy drinks, and single-serve (SS) fresh juice. The additional benefits provided by these beverages when consumed vary depending upon the category. For example, sports drinks provide for rehydration and electrolyte replenishment while, vitamin-enriched water or meal replacement drinks provide a source of specific nutrition. Another category of functional beverages is energy drinks. Energy drinks are intended to produce an alert mental state in addition to a high-energy physical state. Energy drinks are particularly attractive to individuals participating in physically and mentally demanding activities in order to alleviate mental and physical fatigue.

The basis for most energy drinks is a combination of caffeine and a carbohydrate such as glucose. Two double-blind, placebo-controlled, cross-over studies demonstrated that a beverage containing glucose and caffeine can improve cognitive performance (Kennedy D O, Scholey A B. A glucose-caffeine ‘energy drink’ ameliorates subjective and performance deficits during prolonged cognitive demand. Appetite. 2004 June; 42(3):331-3). Combined glucose-caffeine drinks have also been shown to improve attention and performance on mental tasks requiring specific attention (Rao A, Hu H, Nobre A C. The effects of combined caffeine and glucose drinks on attention in the human brain. Nutr Neurosci. 2005 June; 8(3):141-53). Another study found that an energy drink including glucose and caffeine improved specific aspects of memory and attention in a synergistic way that could not be anticipated from individual components (Scholey A B, Kennedy D O. Cognitive and physiological effects of an “energy drink”: an evaluation of the whole drink and of glucose, caffeine and herbal flavouring fractions. Psychopharmacology (Berl). 2004 November; 176(3-4):320-30).

A number of inventions have attempted to provide formulations to increase mental and/or physical energy. For example, U.S. Pat. No. 6,261,589 entitled “Dietary supplement nutrient soft drink composition with psychoactive effect” purports to describe a beverage composition that is a nutrient dietary supplement for increasing energy level and general awareness. It is a carbonated beverage containing phenylalanine, vitamin B-6, vitamin C, copper, folic acid, taurine, vitamin B-5 (or pro-vitamin B-5), choline, fruit sugar, caffeine, and optionally, green tea. The composition is not purported to provide an increase in physical energy and does not contain ginseng or guarana.

U.S. Pat. No. 6,207,203 entitled “Fortified coffee drink” purports to describe a fortified coffee drink providing protein, vitamins and minerals, in addition to caffeine. This invention, devoid of ginseng or taurine, is intended to increase awareness.

U.S. Pat. Application No.: 20030104107A1 entitled “Energy drink formula and method” discloses the formulation of an energy drink including the ingredients glucose, Vitamin B12 and pantothenic acid. The composition does not include caffeine, taurine or ginseng.

U.S. Pat. Application No.: 20040018275A1 entitled “Carbonated energy beverage” describes a composition containing a saccharide, tea or coffee concentrate and B-vitamin complex. The disclosed composition does not include ginseng or taurine.

Despite the number of commercially available ‘energy drinks’, a need exists for a multi-functional energy beverage with the capacity to positively effect both mental and physical attributes.

### SUMMARY OF THE INVENTION

The foregoing needs and other needs and objectives that will become apparent for the following description are achieved in the present invention which comprises a composition and methods of a diet supplement for use in an individual, e.g., a human or an animal. The diet supplement of the present invention may comprise a combination of at least Caffeine Anhydrous, Taurine, an extract of American Ginseng Root and an extract of Green Tea leaf and tender shoots.

According to an embodiment of the present invention, the diet supplement is provided in a ready-to-drink beverage form, which may be consumed several times per day. For instance, the diet supplement comprises at least an eight (8) fluid ounce serving wherein said serving may be consumed several times daily, when the user is experiencing fatigue or drowsiness or alternatively, is in need of heightened mental alertness or physical energy. Consumed in this manner, said diet supplement may quickly increase energy and mental alertness in an individual, e.g. a human or an animal during periods of fatigue or drowsiness, or alternatively during periods when said user is in need of heightened mental alertness or physical energy.

### DETAILED DESCRIPTION OF THE INVENTION

The present invention, in accordance with various embodiments thereof, provides a novel supplemental dietary composition comprising at least a combination of Caffeine Anhydrous, Taurine, an extract of American Ginseng Root and an extract of Green Tea leaf and tender shoots. In another embodiment of the present invention, the supplemental dietary composition may further comprise a combination of one or more of Guarana Seed extract, Calcium Pantothenate, and Vitamin B12. The supplemental dietary composition may quickly increase energy and mental alertness in an individual, e.g. a human or an animal, during periods of fatigue or drowsiness, or alternatively during periods when said user is in need of heightened mental alertness or physical energy.

Caffeine Anhydrous

Caffeine is a naturally occurring xanthine alkaloid found in some plants where it acts as a natural pesticide. In humans it may have numerous beneficial effects. The most common use of caffeine as a supplement is as a central nervous system stimulant and performance enhancer, particularly in terms of mood, mental tasks and alertness (Smith A, Sutherland D, Christopher G. Effects of repeated doses of caffeine on mood and performance of alert and fatigued volunteers. J Psychopharmacol. 2005 November; 19(6):620-6). Biochemically, caffeine binds to, but does not activate, adenosine receptors which are normally activated by adenosine to induce sleep (Shi D, Nikodijevic O, Jacobson K A, Daly J W. Chronic caffeine alters the density of adenosine, adrenergic, cholinergic, GABA, and serotonin receptors and calcium channels in mouse brain. Cell Mol Neurobiol. 1993 June; 13(3):247-61) thereby antagonizing the receptors and inducing a more alert state. Furthermore, Caffeine has also been shown to increase the number of adenosine receptors and inhibit adenylate cyclase activity in the rat cerebral cortex (Ramkumar V, Bumgarner J R, Jacobson K A, Stiles G L. Multiple components of the A1 adenosine receptor-adenylate cyclase system are regulated in rat cerebral cortex by chronic caffeine ingestion. J Clin Invest. 1988 July; 82(1):242-7). This leads to an increase in intracellular cyclic adenyl monophosphate (cAMP), an important signaling molecule, which results in increased epinephrine (adrenalin) and norepinephrin (noradrenalin) levels (Thong F S, Derave W, Kiens B, Graham T E, Urso B, Wojtaszewski J F, Hansen B F, Richter E A. Caffeine-induced impairment of insulin action but not insulin signaling in human skeletal muscle is reduced by exercise. Diabetes. 2002 March; 51(3):583-90; Smith A, Brice C, Nash J, Rich N, Nutt D J. Caffeine and central noradrenaline: effects on mood, cognitive performance, eye movements and cardiovascular function. J Psychopharmacol. 2003 September; 17(3):283-92). Levels of cAMP are also increased by the ability of caffeine to inhibit phosphodiesterases that degrade cAMP (Leblanc J, Richard D, Racotta I S. Metabolic and hormone-related responses to caffeine in rats. Pharmacol Res. 1995 September; 32(3):129-33).

A meta-analysis including forty double-blind studies support the use of caffeine to increase physical endurance (Doherty M, Smith P M. Effects of caffeine ingestion on exercise testing: a meta-analysis. Int J Sport Nutr Exerc Metab. 2004 December; 14(6):626-46). The stimulatory effect of caffeine has also been shown to increase the basal metabolic rate (Astrup A, Toubro S, Cannon S, Hein P, Breum L, Madsen J. Caffeine: a double-blind, placebo-controlled study of its thermogenic, metabolic, and cardiovascular effects in healthy volunteers. Am J Clin Nutr. 1990 May; 51(5):759-67; Dulloo A G, Geissler C A, Horton T, Collins A, Miller D S. Normal caffeine consumption: influence on thermogenesis and daily energy expenditure in lean and postobese human volunteers. Am J Clin Nutr. 1989 January; 49(1):44-50) and improve athletic performance (Dodd S L, Herb R A, Powers S K. Caffeine and exercise performance. An update. Sports Med. 1993 January; 15(1): 14-23).

In various embodiments of the present invention which are set forth in greater detail in the example below, the diet supplement includes Caffeine Anhydrous. A serving of the diet supplement may include from about 0.050 g to about 2.000 g of Caffeine Anhydrous. The preferred dosage, in a serving of said diet supplement, comprises about 0.110 g of Caffeine Anhydrous.

Taurine

Taurine is an amino acid found primarily in nerve and muscle tissue. Taurine is generally considered to be a conditionally-essential amino acid, wherein it is only required under certain circumstances. However, as it is not utilized for protein synthesis, it is found in free form or in some small peptides.

One of the main roles of taurine is the regulation of fluid balance and it is also released by contracting muscles (Cuisinier C, Michotte De Welle J, Verbeeck R K, Poortmans J R, Ward R, Sturbois X, Francaux M. Role of taurine in osmoregulation during endurance exercise. Eur J AppI Physiol. 2002 October; 87(6):489-95). Taurine has also been shown to modulate the contractile function of mammalian skeletal muscle (Bakker A J, Berg H M. Effect of taurine on sarcoplasmic reticulum function and force in skinned fast-twitch skeletal muscle fibres of the rat. J Physiol. 2002 Jan. 1; 538(Pt 1):185-94). In rats, the taurine concentration in muscle decreases as a result of exercise (Matsuzaki Y, Miyazaki T, Miyakawa S, Bouscarel B, Ikegami T, Tanaka N. Decreased taurine concentration in skeletal muscles after exercise for various durations. Med Sci Sports Exerc. 2002 May; 34(5):793-7) and oral supplementation with taurine can maintain the concentration of taurine in muscles and prolong exercise performance (Miyazaki T, Matsuzaki Y, Ikegami T, Miyakawa S, Doy M, Tanaka N, Bouscarel B. Optimal and effective oral dose of taurine to prolong exercise performance in rat. Amino Acids. 2004 December; 27(3-4):291-8; Yatabe Y, Miyakawa S, Miyazaki T, Matsuzaki Y, Ochiai N. Effects of taurine administration in rat skeletal muscles on exercise. J Orthop Sci. 2003;8(3):415-9). Supplementation with taurine has been shown to reduce exercise-induced oxidative damage and enhance recovery (Zhang M, Izumi I, Kagamimori S, Sokejima S, Yamagami T, Liu Z, Qi B. Role of taurine supplementation to prevent exercise-induced oxidative stress in healthy young men. Amino Acids. 2004 March; 26(2):203-7).

In various embodiments of the present invention which are set forth in greater detail in the example below, the diet supplement includes Taurine. A serving of the diet supplement may include from about 0.050 g to about 0.200 g of Taurine. The preferred dosage, in a serving of said diet supplement, comprises about 0.100 g of Taurine.

American Ginseng Root Extract (Panax quinquefolius)

The most common types of ginseng are Chinese ginseng (Panax ginseng) and American ginseng (Panax quinquefolius). All ginseng species share the same general active ingredients, wherein the main ingredients are a group of saponin triterpenoid glycosides called “ginsenosides”. American Ginseng is native to North America.

Extracts of American Ginseng have significant antioxidant activity in both aqueous and lipid environments (Kitts D D, Wijewickreme A N, Hu C. Antioxidant properties of a North American ginseng extract. Mol Cell Biochem. 2000 January; 203(1-2):1-10). Furthermore, extracts of American Ginseng have been shown to possess hypoglycemic activity in both mice (Oshima Y, Sato K, Hikino H. Isolation and hypoglycemic activity of quinquefolans A, B, and C, glycans of Panax quinquefolium roots. J Nat Prod. 1987 March-April; 50(2):188-90) and in diabetic and non-diabetic humans (Vuksan V, Sievenpiper J L, Koo V Y, Francis T, Beljan-Zdravkovic U, Xu Z, Vidgen E. American ginseng (Panax quinquefolius L) reduces postprandial glycemia in nondiabetic subjects and subjects with type 2 diabetes mellitus. Arch Intern Med. 2000 Apr. 10; 160(7):1009-13). Hypoglycemia or low blood glucose may indicate improved availability or usage of glucose for energy.

In various embodiments of the present invention which are set forth in greater detail in the example below, the diet supplement includes an extract of American Ginseng root (Panax quinquefolius). A serving of the diet supplement may include from about 0.005 g to about 0.025 g of an extract of American Ginseng root (Panax quinquefolius). The preferred dosage, in a serving of said diet supplement, comprises about 0.010 g of an extract of American Ginseng (Panax quinquefolius).

Green Tea Green Leaf & Tender Shoot Extract (Camellia sinesis)

All teas (green, black, white and oolong) are derived from the same plant (Camellia sinensis) however different methods of processing are employed, resulting in different proportions of active compounds. Indeed, Green tea undergoes the least processing, thereby leaving more active compounds.

The active compounds of tea are a family of polyphenols, particularly the catechins. The most active specific compound is the catechin epigallocatechin gallate (ECGC) which comprises 10-50% of the total catechins (Kao Y H, Hiipakka R A, Liao S. Modulation of endocrine systems and food intake by green tea epigallocatechin gallate. Endocrinology. 2000 March; 141(3):980-7). Green tea also contains caffeine, although typically significantly less than black tea.

Green tea has been shown to increase energy expenditure (Berube-Parent S, Pelletier C, Dore J, Tremblay A. Effects of encapsulated green tea and Guarana extracts containing a mixture of epigallocatechin-3-gallate and caffeine on 24 h energy expenditure and fat oxidation in men. Br J Nutr. 2005 September; 94(3):432-6). In mice, Green tea extract has been shown to increase running endurance by increasing metabolism and enhancing the use of fat as an energy source (Murase T, Haramizu S, Shimotoyodome A, Tokimitsu I, Hase T. Green tea extract improves running endurance in mice by stimulating lipid utilization during exercise. Am J Physiol Regul lntegr Comp Physiol. 2006 June; 290(6):R1550-6). Similar results have been obtained in human studies showing that Green tea extract increases energy output while oxidizing fat (Dulloo A G, Duret C, Rohrer D, Girardier L, Mensi N, Fathi M, Chantre P, Vandermander J. Efficacy of a green tea extract rich in catechin polyphenols and caffeine in increasing 24-h energy expenditure and fat oxidation in humans. Am J Clin Nutr. 1999 December; 70(6):1040-5).

The catechins in Green tea are also known to inhibit catechol-O-ethyl-transferase (COMT), an enzyme that degrades norepinephrine (Borchardt R T, Huber J A. Catechol O-methyltransferase. 5. Structure-activity relationships for inhibition by flavonoids. J Med Chem. 1975 January; 18(1):120-2). Norepinephrine and epinephrine increase the levels of cAMP (MacGregor D A, Prielipp R C, Butterworth J F 4th, James R L, Royster R L. Relative efficacy and potency of beta-adrenoceptor agonists for generating cAMP in human lymphocytes. Chest. 1996 January; 109(1):194-200). Therefore, Green tea may be expected to have effects similar to caffeine. In fact, the increased energy expenditure stimulated by Green tea is synergistically enhanced by caffeine (Dulloo A G, Seydoux J, Girardier L, Chantre P, Vandermander J. Green tea and thermogenesis: interactions between catechin-polyphenols, caffeine and sympathetic activity. Int J Obes Relat Metab Disord. 2000 February; 24(2):252-8).

In various embodiments of the present invention which are set forth in greater detail in the example below, the diet supplement includes an extract of Green Tea green leaf and tender shoots (Camellia sinesis). A serving of the diet supplement may include from about 0.005 g to about 0.025 g of an extract of Green Tea green leaf and tender shoots (Camellia sinesis). The preferred dosage, in a serving of said diet supplement, comprises about 0.010 g of an extract of Green Tea green leaf and tender shoots (Camellia sinesis).

Guarana Seed Extract (Paullina cupana)

Guarana comes from the seeds of a South American plant (Paullina cupana). Guarana is known to be rich in caffeine and as such has similar benefits. In mice, Guarana extract has been shown to increase physical activity capacity and improve memory (Espinola E B, Dias R F, Mattei R, Carlini E A. Pharmacological activity of Guarana (Paullinia cupana Mart.) in laboratory animals. J Ethnopharmacol. 1997 February; 55(3):223-9). For example, in one double-blind, placebo-controlled study examining the effects of Guarana on behavior measured improvements in memory and alertness that were not solely attributable to caffeine (Haskell C F, Kennedy D, Wesnes K A, Milne A L, Scholey A B. A double-blind, placebo-controlled, multi-dose evaluation of the acute behavioural effects of guarana in humans. J Psychopharmacol. 2006 Mar. 13).

In various embodiments of the present invention which are set forth in greater detail in the example below, the diet supplement includes Guarana seed extract (Paullina cupana). A serving of the diet supplement may include from about 0.0020 g to about 0.0150 g of Guarana seed extract (Paullina cupana). The preferred dosage, in a serving of said diet supplement, comprises about 0.0096 g of Guarana seed extract (Paullina cupana).

Calcium Pantothenate (Vitamin B5)

Calcium Pantothenate is a supplemental form of Pantothenic Acid. Pantothenic Acid (vitamin B5) is one of eight water-soluble B-vitamins and is important in the metabolism of carbohydrates. Moreover, Pantothenic Acid is a precursor of coenzyme A which is involved in carbohydrate metabolism.

Interestingly, studies have shown that the typical North American diet is low in Pantothenic Acid (Tarr J B, Tamura T, Stokstad E L. Availability of vitamin B6 and pantothenate in an average American diet in man. Am J Clin Nutr. 1981 July; 34(7):1328-37).

In various embodiments of the present invention which are set forth in greater detail in the example set forth below, the diet supplement includes Calcium Pantothenate. A serving of the diet supplement may include from about 0.0005 g to about 0.004 g of Calcium Pantothenate. The preferred dosage, in a serving of said diet supplement, comprises about 0.0015 g of Calcium Pantothenate.

Cyanocobalamin (Vitamin B12)

Vitamin B12 (Cobalamin) is a cobalt-containing vitamin in the Vitamin B complex. It is obtained in the diet mainly from meat and dairy products. Vitamin B12 is involved in the metabolism of proteins, fats, and carbohydrates and is used to produce succinyl CoA, an intermediary in the Krebs cycle that generates ATP for energy. Vitamin B12 deficiency has been linked to anemia and a number of neuropsychiatric disorders which can be effectively treated with oral supplementation (Oh R, Brown D L. Vitamin B12 deficiency. Am Fam Physician. 2003 Mar. 1; 67(5):979-86).

In various embodiments of the present invention which are set forth in greater detail in the example set forth below, the diet supplement includes Vitamin B12. A serving of the diet supplement may include from about 0.0002 g to about 0.00020 g of Vitamin B12. The preferred dosage, in a serving of said diet supplement, comprises about 0.00090 g of Vitamin B12.

In an embodiment of the present invention, which is set forth in greater detail in the example below, the supplemental dietary composition comprises at least Caffeine Anhydrous, Taurine, an extract of American Ginseng root (Panax quinquefolius) and an extract of Green Tea leaf and tender shoots (Camellia sinesis). The supplemental dietary composition may further comprise one or more of an extract of Guarana seed (Paullina cupana), Calcium Pantothenate (Vitamin B5) and Vitamin B12.

According to various embodiments of the present invention, the supplemental dietary composition may be consumed in any form. For instance, the dosage form of the supplemental dietary composition may be provided as, e.g. a beverage mix, a liquid beverage, e.g. an energy drink, a ready-to-drink beverage, a ready-to-eat bar, a capsule, a tablet, a caplet, or as a dietary gel. The most preferred dosage form is as an energy drink product. The supplemental dietary composition may be consumed any number of times per day in order to obtain any one or more of the benefits set forth above. For example, in an embodiment, the supplemental dietary composition may be consumed one or two times per day whenever any one of the benefits set forth above is desired.

Furthermore, the dosage form of the supplemental dietary composition may be provided in accordance with customary processing techniques for herbal and/or dietary supplements in any of the forms mentioned above. Also, the supplemental dietary composition set forth in the example embodiment herein contains any appropriate number and type of excipients, as is well known in the art.

Although the following example illustrates the practice of the present invention in one of its embodiments, the example should not be construed as limiting the scope of the invention. Other embodiments will be apparent to one skilled in the art from consideration of the specification of the following example.

### EXAMPLE

A diet supplement for increasing energy and mental alertness in an individual, e.g. a human or an animal during periods of fatigue or drowsiness, is provided, the diet supplement comprising about 0.1100 g of Caffeine Anhydrous, about 0.1000 g of Taurine, about 0.0100 g of an extract of American Ginseng Root (standardized to 4% Ginsenosides), about 0.0100 g of an extract of Green Tea Leaf and Tender Shoot (standardized to 15% epigallocatechin gallate, 35% catechins, 50% Polyphenols, 4% Caffeine), about 0.0096 g of an extract of Guarana Seed (standardized to 36% Caffeine), about 0.0015 g of Calicum Pantothenate (comprising about 8.2% Calcium and 91.4% Panthotenoic Acid), and about 0.0009 g of Vitamin B12.

Directions: As a diet supplement, at least eight (8) fluid ounces of said diet supplement are administered orally during periods of fatigue or drowsiness or alternatively during periods wherein the user is in need of heightened mental alertness or physical energy. Each eight (8) fluid ounce serving may be consumed as needed throughout the day.

In the foregoing specification, the invention has been described with specific embodiments thereof; however, it will be evident that various modifications and changes may be made thereto without departing from the broader spirit and scope of the invention.

What is claimed:

1. A composition comprising at least a combination of Caffeine Anhydrous, Taurine, an extract of American Ginseng Root and an extract of Green Tea leaf and tender shoots.

2. The composition of claim 1, further comprising Guarana Seed extract.

3. The composition of claim 2, further comprising Calcium Pantothenate.

4. The composition of claim 3, further comprising Vitamin B12.

5. The composition of claim 1, further comprising water.

6. The composition of claim 5, wherein said water uncarbonated.

7. The composition of claim 5, wherein said water is carbonated.

8. A composition comprising:
about 0.1100 g of Caffeine Anhydrous;
about 0.1000 g of Taurine;
about 0.0100 g of an extract of American Ginseng Root; and
about 0.0100 g of an extract of Green Tea Leaf and tender shoots.

9. The composition of claim 8, further comprising water.

10. The composition of claim 8, further comprising carbonated water.

11. The method of claim 8, wherein said composition is provided as a liquid.

12. A method of increasing energy and mental alertness in an individual, comprising the step of administering to the individual the composition of claim 1.

13. The method claim 12, wherein said composition is provided as a ready-to-drink beverage product.
